(19) United States
(12) Patent Application Publication
(10) Pub. No.: US 2017/0193611 A1
(43) Pub. Date: Jul. 6, 2017

(54) METHOD AND COMPUTING SYSTEM ADAPTED FOR SERVICE AUTO-RESPONSE GENERATION BASED UPON SOCIAL MEDIA POSTING

(71) Applicant: 44LAB5, LLC, La Plata, MD (US)

(72) Inventors: Vesselin Dimitrov Vassilev, Baltimore, MD (US); Luke H. Hannah, La Plata, MD (US); Thomas E. Hannah, Chesterfield, MO (US)

(73) Assignee: 44LAB5, LLC, La Plata, MD (US)

(21) Appl. No.: 15/464,490

(22) Filed: Mar. 21, 2017

Related U.S. Application Data
(63) Continuation-in-part of application No. 14/997,298, filed on Jan. 15, 2016, now abandoned.
(60) Provisional application No. 62/105,770, filed on Jan. 21, 2015.

(51) Int. Cl. G06Q 50/00; G06Q 40/08; H04W 4/02; G06F 17/30; H04L 12/58; H04L 12/24

(52) U.S. Cl. CPC G06Q 50/01; H04L 51/32; H04L 51/02; H04L 41/02; H04W 4/021; G06F 17/30867; G06Q 40/08

(57) ABSTRACT

An example computer-implemented method and computer system, each adapted for service auto-response generation based upon social media posting, are described herein. In the method, one or more social media sources on the internet are continually scrubbed to search for a social media posting posted by a poster, and to extract information from the social media posting upon detection of at least one keyword therein. The extracted information is compared to a stored set of keywords of subscribers to look for a match to a subscriber. If a match is found between the subscriber and poster, an auto-response message of the subscriber which addresses the content in the social media posting is immediately sent to the poster to initiate contact.

### CROSS-REFERENCE TO RELATED APPLICATIONS

The present application is a continuation-in-part of and claims the benefit under 35 U.S.C. §120 to U.S. patent application Ser. No. 14/997,298 to Luke H. Hannah, et al., filed Jan. 15, 2016, pending, which in turned claimed the benefit under 35 U.S.C. §119(e) of U.S. Prov. Pat. Appl. Ser. No. 62/105,770 to Luke H. Hannah, et al., filed Jan. 21, 2015, expired. The entire contents of this provisional application is hereby incorporated by reference herein.

### BACKGROUND

Field

Example embodiments in general relate to a computer system and computer-implemented method adapted for service auto-response generation based upon social media posting.

Related Art

Online social networks enable users of a social media platform to communicate with one another publicly and privately. Users may communicate with friends, strangers and businesses. For example, many businesses have TWITTER® and FACEBOOK® accounts that enable the businesses to interact with their customers and/or potential customers. Businesses may use social networks to advertise products, services, or promotions and/or respond to users' questions and complaints.

In general, the phrase “social media” may be understood as the use of Web-based and mobile technologies to turn communication into an interactive dialogue. Andreas Kaplan and Michael Haenlein define social media as “a group of Internet-based applications that build on the ideological and technological foundations of Web 2.0 and that allow the creation and exchange of user-generated content.” (See, Kaplan, Andreas M.; Michael Haenlein (2010); Users of the world unite!—The challenges and opportunities of Social Media; Business Horizons 53 (1): 59-68).

Social media has thus been developed for social interactions. Enabled by ubiquitously accessible and scalable communication techniques, social media has substantially changed communication between organizations, communities, as well as between individuals. Social media may take on many different forms, such as Internet forums, weblogs, social blogs, micro-blogging, wikis, podcasts, photographs or pictures, video, rating, and social bookmarking. By applying a set of theories in the field of media research, e.g., social presence, media richness, and social processes, e.g. self-presentation, self-disclosure, Kaplan and Haenlein (ibid) created a classification scheme for different social media types. According to Kaplan and Haenlein, there are six different types of social media: collaborative projects, e.g. Wikipedia, blogs and micro-blogs, e.g., TWITTER, content communities, e.g., YOUTUBE®, social networking sites, e.g., FACEBOOK, LINKED IN®; virtual game worlds, e.g., WORLD OF WARCRAFT®, and virtual social worlds, e.g., SECOND LIFE®. Technologies include: blogs, picture-sharing, vlogs, wall postings, email, instant messaging, music-sharing, crowd-sourcing, voice over IP, and the like. Many of these social media services can be integrated via social network aggregation platforms.

It has been observed that FACEBOOK is now the primary method for communication by college students in the U.S. There are various statistics that account for social media usage and effectiveness for individuals worldwide. Some of the most recent statistics include: (i) a new study reveals that internet users in 2014 now spend a daily average of 6.09 hours on online media, and more than one full quarter of all that time that is used by social networking on platforms such as FACEBOOK, TWITTER, SNAPCHAT® and INSTAGRAM®. GLOBALWEB INDEX™ surveyed internet users aged 16-64 and found that 28 percent of all time spent online as of April 2014 is consumed by social media, which equates to about 1.69 hours each and every day; (ii) COMSCORE®, Inc., a leader in measuring the digital world, released data from their MOBILENS® and MOBILE METRIX®, reporting key trends in the U.S. smartphone industry for July 2014. These reports indicate that 173 million people in the U.S. owned smartphones (71.8 percent mobile market penetration) during the three months ending in July 2014; (iii) As of December 2014, TWITTER had more than 500 million users, out of which more than 284 million were active users.

In 2016, approximately 6,000 tweets are tweeted on TWITTER per second, which corresponds to over 350,000 tweets sent per minute, 500 million tweets per day and around 200 billion tweets per year. However, the number of active users is now dwarfed by INSTAGRAM, whose CEO Kevin Systrom told the BBC in December 2014 that “monthly active users of the service now total upwards of 300 million.”; (iv) As part of its financial results for its 2013 fourth quarter, FACEBOOK announced that its social network passed 1.23 billion monthly active users. Of those, daily active users passed 757 million on average during December 2013, and the number of monthly active mobile users hit 945 million.

“Social Media Revolution”, produced by Socialnomics author Erik Qualman, contains numerous statistics on social media, including the fact that 93% of businesses use it for marketing and that if Facebook were a country, it would be the third largest. In an effort to supplant FACEBOOK's dominance, GOOGLE® launched GOOGLE+® in the summer of 2011.

Using social media as a form of marketing has thus taken on a whole new set of challenges. The 2013 Nielsen Global Trust in Advertising and Messages report, which polls over 29,000 consumers in 58 countries, notes that although recommendations from friends and family and consumer opinions posted online remain the most trusted form of messaging, online and mobile advertising formats reported some of the biggest increases in trust since Nielsen's 2007 report. Accordingly, advertisers are exhibiting growing confidence in these formats; while companies are unable to directly control their messaging in earned media (such as consumer opinions posted online), they have the ability to create a positive presence for their brands on these channels.

As the 2013 Nielsen Trust study indicates, it is most effective if campaigns and/or marketing efforts through social media revolve around the genuine building of trust. Someone performing a marketing role within a company must honestly convince people of their genuine intentions, knowledge, and expertise in a specific area or industry through providing valuable and accurate information on an ongoing basis without a marketing angle overtly associated.

In Applicants' co-pending and commonly assigned U.S. patent application Ser. No. 14/997,298 to Luke H. Hannah, et al, filed Jan. 15, 2016, (the “'298 application”), a method was described in which a social media source was continually scrubbed to search for a social media posting posted by a poster thereon. The posting was pulled down and metadata contained therein was analyzed to calculate a score. The calculated score was compared to filter criteria and, on condition that the score passed the filter criteria, a subscribing client selected from a group thereof was assigned to the poster, with an auto-generated response sent to the poster so as to initiate contact therewith.

In beta testing, this model proved to be bogged down by larger volumes of web traffic. In other words, the processing could not keep up with the heavy traffic of streaming posts and tweets that is typically present on the internet and which occurs continuously. Thus, the method of the '298 application did not prove to be scalable.

### SUMMARY

An example embodiment of the present invention is directed to a computer-implemented method implemented by processing power of a computing device, the method adapted to link a social media poster to a subscriber so as to attain a conversion event. In the method, one or more social media sources on the internet are continually scrubbed to search for a social media posting posted by a poster, and more particularly to find a predetermined keyword within the content of the social media posting. Upon keyword detection, information from the social media posting is then extracted, and then analyzed in an effort to link the poster and subscriber. If a match is found between the subscriber and poster, an auto-response message of the subscriber is immediately sent to the poster to initiate contact therewith so as to attain the conversion event.

Another example embodiment is directed to a computer system adapted to link a social media poster to a subscriber so as to attain a conversion event. The system includes a processing hardware set and computer readable storage device medium, the processing hardware set being structured, connected and/or programmed to run program instructions stored on the computer readable storage medium and associated data. The system also includes an action client programmed to continually scrub one or more social media sources on the internet to search for a social media posting posted by a poster, to search for at least one selected or predetermined keyword contained in the content of the social media posting, and to extract information from the social media posting upon detection of the at least one keyword therein, and a decision client programmed to analyze the extracted information in an effort to link the poster and subscriber, and determine if a match is found based on the analysis. The system further includes a response client programmed to, upon a found match by the decision client, send an auto-response message of the subscriber to the poster so as to initiate contact therewith and attain the conversion event, the generated auto-response addressing content within the social media posting.

Another example embodiment is directed to a method adapted to link a social media poster of a post or tweet containing content related to an insurance loss event to a subscriber service provider. The method includes continually scrubbing one or more social media sources on the internet to search for a social media posting posted by a poster, extracting information from the social media posting upon detection of at least one keyword therein, and comparing the extracted information to a stored set of keywords. If a match is found between the subscriber and poster, an auto-response message of the subscriber is sent to the poster to attain the conversion event.

Another example embodiment is directed to a computer system adapted to link a social media poster of a post or tweet containing content related to an insurance loss event to a subscriber service provider. The system includes an action client adapted to continually scrub one or more social media sources on the internet to search for a social media posting posted by a poster, and to extract information from the social media posting upon detection of at least one keyword therein. The system includes a decision server adapted to compare the extracted information to a stored set of keywords, and a response client. If a match is found between the subscriber and poster, the response client sends an auto-response message of the subscriber to the poster to initiate contact.

### BRIEF DESCRIPTION OF THE DRAWINGS

Example embodiments will become more fully understood from the detailed description given herein below and the accompanying drawing, wherein like elements are represented by like reference numerals, which are given by way of illustration only and thus are not limitative of the example embodiments herein.

FIG. 1 illustrates an exemplary general computer system block diagram adapted to implement a method for service auto-response generation based upon a social media posting, in accordance with some embodiments.

FIG. 2 is a simplified block diagram of a specific computer system for implementing the method.

FIG. 3 is a block diagram describing the architecture of a virtual machine.

FIG. 4 is a block diagram describing the general architecture of a container.

FIG. 5 is a block diagram describing the architecture of an exemplary DOCKER® containerization platform.

FIG. 6 is a block diagram describing the architecture of another exemplary DOCKER® containerization platform.

FIG. 7 is a block diagram describing the general architecture of an exemplary server node for determining a match between a post by a social media poster and a subscriber, according to the exemplary computer-implemented method.

FIG. 8 is a block diagram describing the server node shown in FIG. 7 in more detail.

FIG. 9 is a flow diagram to describe a method for service auto-response generation based upon a social media posting, according to the example embodiments.

FIG. 10 is a flow diagram to describe an auto-scaling methodology that is implemented in parallel with the method for service auto-response generation described in FIG. 9.

FIG. 11 is a screenshot of a chat box illustrating an example post on TWITTER evaluated by the exemplary method.

FIG. 12 is screenshot of a chat box illustrating an example auto-generated response by the subscriber client selected or assigned by exemplary method to address the post in FIG. 11.

FIG. 13 is a screenshot of a chat box illustrating another example post evaluated by the exemplary method.

FIG. 14 is screenshot of a chat box illustrating an example auto-generated response by the subscriber client selected or assigned by the exemplary method to address the post in FIG. 13.

FIG. 15 is a screenshot of another timeline example using the exemplary method to address separate burst pipe and broken windshield tweets.

FIG. 16 is a screenshot showing a graph of a one month snapshot of tweets in spring 2015 which include duct/vent cleaning keywords therein, as tracked by an analytics vendor.

FIG. 17 is a screenshot showing a graph of a one month snapshot of tweets in spring 2015 which include fire damage-related keywords therein, as tracked by the analytics vendor.

FIG. 18 is a screenshot showing a graph of a one month snapshot of tweets in spring 2015 which include Paleo-related keywords therein, as tracked by the analytics vendor.

FIG. 19 is a screenshot showing a graph of a one month snapshot of tweets in spring 2015 which include water damage-related keywords therein, as tracked by the analytics vendor.

FIG. 20 is a screenshot showing a graph of a one month snapshot of tweets in spring 2015 which include windshield damage-related keywords therein, as tracked by the analytics vendor.

### DETAILED DESCRIPTION

In general, in an effort to provide an overview of the example method, which may be implemented by a computer system or computing device, and which may be embodied as non-transitory computer readable information storage media or a set of machine readable instructions and associated data stored in a storage device, a metacrawling or data mining-based algorithm, referred to hereafter occasionally as a “SCRBR algorithm” or “process 1000” continually runs on a client of the example computer system or device to scrub through at least 150,000,000 daily tweets (or posts) (which at the time of the drafting of this disclosure represents the daily number of tweets processed by TWITTER) to search out posts or tweets containing one or more selected or predetermined keywords therein. In doing the scrub, the SCRBR algorithm analyzes metadata in the social media posting in an effort to link the poster up with a subscriber of the SCRBR service (which may be a service provider business entity) that can address the content of the issue in the post or tweet made by the poster/tweeter. The system analyzes the information and if a match is found between the poster/tweeter and a subscriber of the service, an auto-generated response is immediately sent to the poster/tweeter in reply to the tweet. Additional details of these functions are described in further detail hereafter

In one example, a website in communication with the inventive computer system for implementing the example method may be accessible by subscribers in a self-serve manner. In another example, the website describing the services may be public-facing and serve essentially as a sales brochure for a downloadable app. In addition to promoting the mobile app, the website may promote perspectives on personal finances through a link to an associated blog. The blog may also be accessible through social media where, for example, it posts regularly to FACEBOOK, TWITTER, INSTAGRAM, and LINKED IN.

The commercial platform thus is envisioned as a self-serve website, downloadable app, or both, each based on the example computer system(s) and computer-implemented method described hereafter. The commercial platform may be directed to multiple sales channels and campaigns, including but not limited to: (a) B2C direct via the mobile app downloaded from a digital distribution service such as the GOOGLE PLAY™, AMAZON® Appstore and/or App Store by APPLE: (b) a B2B relationship whereby the servicers may be licensed and offered under a designated brand (e.g., smaller service providers, affinity groups, their agents and the like); and (c) a B2B relationship whereby the licensing entity rebrands the service for integration into their product suite (e.g., a larger service provider company).

As will be appreciated by one skilled in the art, the example embodiments of the present invention may be embodied as a computing system, computing device, computer-implemented method, set of machine-readable instructions and associated data in a manner more persistent than a signal in transit, non-transitory computer-readable media, and/or as a computer program product or downloadable mobile app product for a mobile device. Accordingly, aspects of the example embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the example embodiments may take the form of a computer program product embodied in one or more computer-readable medium(s) having computer-readable program code/instructions embodied thereon.

As used herein, the phrase “present invention” should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed as maybe being new; this understanding, as indicated by use of the term “present invention,” is tentative and provisional and subject to change over the course of patent prosecution as relevant information is developed and as the claims are potentially amended. Additionally, and unless the context requires otherwise, throughout the specification and claims that follow, the word “comprise” and variations thereof, such as “comprises” and “comprising,” are to be construed in an open, inclusive sense, that is, as “including, but not limited to.”

As used herein, the terms “program” or “software” are employed in a generic sense to refer to any type of computer code or set of computer-executable instructions that can be employed to program a computer or other processor to implement various aspects of the present invention as discussed above. Additionally, it should be appreciated that one or more computer programs that when executed perform methods of the example embodiments need not reside on a single computer or processor, but may be distributed in a modular fashion amongst a number of different computers or processors to implement various aspects of the example embodiments.

Computer-executable instructions may be in many forms, such as program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish a relationship between data elements.

Additionally, a “computing device” as used hereafter encompasses any of a smart device, a firewall, a router, and a network such as a LAN/WAN. As used herein, a “smart device” is an electronic device, generally connected to other devices or networks via different wireless protocols such as Bluetooth, NFC, WiFi, 3G, 4G, etc., that can operate to some extent interactively and autonomously. Smart devices include but are not limited to smartphones, PCs, laptops, phablets and tablets, smartwatches, smart bands and smart key chains. A smart device can also refer to a ubiquitous computing device that exhibits some properties of ubiquitous computing including—although not necessarily—artificial intelligence. Smart devices can be designed to support a variety of form factors, a range of properties pertaining to ubiquitous computing and to be used in three primary system environments: physical world, human-centered environments, and distributed computing environments.

The computer system(s), device(s), method(s), computer program product(s) and the like, as described in the following example embodiments, may be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means or the like. In general, any device(s) or means capable of implementing the methodology illustrated herein can be used to implement the various aspects of the example embodiments.

The example computer system described hereafter can include clients and servers. A client and server are generally remote from each other and typically interact over a communication network. The relationship of client and server arises by virtue of computer programs running on the respective computers and having a client-server relationship to each other.

Exemplary hardware that can be used for the example embodiments includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus or device, or any suitable combination of the foregoing. A non-exhaustive list of specific examples for a computer-readable storage medium would include at least the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In the context of this Detailed Description, a computer-readable storage medium may be any tangible medium that can contain or store a program for use by or in connection with an instruction execution system, apparatus or device. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Accordingly, the present invention foresees that a non-transitory computer-readable information storage media having stored thereon information, that, when executed by a processor, causes the steps described in more detail hereafter in the example method(s) to be performed.

A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including but not limited to wireless, wireline, optical fiber cable, RF, etc., or any suitable combination of the foregoing.

The techniques described in the following example embodiments may also be implemented in a distributed computing system that includes a back-end component, e.g., as a data server, and/or a middleware component, e.g., an application server or proxy web server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

Computer program code for carrying out operations for aspects or embodiments of the present invention may be written in any combination of one or more programming languages, including a programming language such as JAVASCRIPT®, JAVA®, SQL™, PHP™, RUBY™, PYTHON®, JSON, HTML5™, OBJECTIVE-C®, SWIFT™, XCODE®, SMALLTALK™, C++ or the like, conventional procedural programming languages, such as the “C” programming language or similar programming languages, any other markup language, any other scripting language, such as VBScript, and many other programming languages as are well known may be used.

The program code may execute entirely on a user's computing device, partly on the user's computing device, as a stand-alone software package, partly on the user's computing device and partly on a remote computer or entirely on the remote computer or server. In the latter scenario, the remote computer may be connected to the user's computing device through any type of network, including a LAN or WAN, or the connection may be made to an external computer (for example, through the Internet using an Internet Service Provider).

Method or function steps of the embodiments described herein can be performed by one or more programmable processors executing a computer program or program code to perform functions of the invention by operating on input data and generating output. Method or function steps can also be performed by, and system and/or apparatus of the invention can be implemented as, special purpose logic circuitry, e.g., an FPGA (field programmable gate array) or an ASIC (application-specific integrated circuit). Modules may refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the embodiments described herein can be implemented on a computer system having a display device, e.g., a CRT (cathode ray tube) LED (light emitting diode), or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Example embodiments and aspects of the present invention are described below with reference to flowchart illustrations and/or block diagrams of methods, apparatus (systems) and computer program products according to embodiments of the invention. Each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other computing devices to function in a particular manner, such that the instructions stored in the computer-readable medium produce an article of manufacture including instructions which implement the function/act specified in the flowchart and/or block diagram block or blocks.

The computer program instructions may also be loaded onto a computer system, other programmable data processing apparatus, or other computing devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

As used hereafter, the term “cloud” or phrase “cloud computing” means storing and accessing data and programs over the Internet instead of a computing device's hard drive. The cloud is a metaphor for the Internet.

Further, and as used herein, the term “server” is meant to include a computer system, including processing hardware and process space(s), and an associated storage system and database application (e.g., OODBMS or RDBMS) as is well known in the art. It should also be understood that the terms or phrases such as “server system”, “server”, “server node”, “POD” and/or “POD processing” are often used interchangeably herein. Similarly, any kind of database object described herein can be implemented as single databases, a distributed database, a collection of distributed databases, a database with redundant online or offline backups or other redundancies, etc., and might include a distributed database or storage network and associated processing intelligence.

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise. As used in the specification and appended claims, the terms “correspond,” “corresponds,” and “corresponding” are intended to describe a ratio of or a similarity between referenced objects. The use of “correspond” or one of its forms should not be construed to mean the exact shape or size. Further, and in the drawings, identical reference numbers identify similar elements or acts. The size and relative positions of elements in the drawings are not necessarily drawn to scale.

As used herein, the term “post” refers in general to a message posted in any online forum or newsgroup. When referring to a message board, a post refers to an article published on an Internet newsgroup, forum, or other bulletin board area. It is also the act of publishing such a message.

As used herein, the term “tweet” refers in general to a post made on the TWITTER online message service. A tweet is an online posting, or “micro-blog” created by a Twitter user. The purpose of each tweet is to answer the question, “What are you doing?” However, tweets can contain any information the poster (user) wants to post, such as plans for the weekend, thoughts about a TV show, or even notes from a lecture. The poster can publish a tweet using a computer or a mobile phone. Once published, the tweet will appear on the TWITTER home pages of all the users that are following the poster. Likewise, the poster's TWITTER home page will display the most recent tweets of users that the poster is following. Since each tweet is limited to 140 characters or less, it possible to show several tweets on one page without certain tweets taking up substantially more space than others.

The example method and computer system described hereafter are configured to evaluate social media sources in order to match up a subscriber client with a poster to address a problem or issue of the poster. Social media sources in general include any social media website in which one has access to the application program interface (API) of the website. As is well known, the API is a set of routines, protocols, and tools for building software applications. The API specifies how software components should interact and are used when programming graphical user interface (GUI) components.

Social media sources include social networking platforms or websites including but not limited to FACEBOOK, TWITTER, LINKED IN, MYSPACE®, FRIENDSTER® and TUMBLR®, that allow individuals to post updates and make comments that are immediately shared with others. Social media sources also include platforms or websites such as INSTAGRAM, FLICKR®, PINTEREST® and YOUTUBE® that allow users to post video and image content. In some cases, posts are “public,” meaning publicly accessible; in other cases, posts are “private,” meaning that such posts are shared only with pre-authorized individuals.

As examples, a post includes a user-generated post of text data. Messages include text created by a user, and may include other data as well. Examples of messages include posts such as tweets, user status updates, and comments. Messages can be created for a user's profile or for a record. Posts can be created by various users, potentially any user, although some restrictions can be applied. As an example, posts can be made to a wall section of a user's profile (which can include a number of recent posts) or a section of a record that includes multiple posts. The posts can be organized in chronological order when displayed in a graphical user interface (GUI). In one implementation, a comment can be made on any post. In another implementation, comments are organized as a list explicitly tied to a particular post.

As to be set forth more fully below, the example embodiments in general are directed to a computer-implemented method having one or more steps implemented by a computing system or computing device so as to force a conversion event, based on a post scrubbed from a social media source on the internet, between the social media poster of that post or tweet, and a subscriber of the SCRBR service. In attaining this conversion event, a core goal of the SCRBR service is thus matching up the poster's response (tweet/post) to the subscriber of the SCRBR service such that it leads to a business interaction between a subscriber of the SCRBR service and the poster of the post or tweet, perhaps directing the poster to a landing page of the subscriber via an auto-generated message.

In another example, a non-transitory, computer-readable information storage media having stored thereon information is envisioned. When executed by a processor, this stored information causes to be performed the steps of the method. In another example, the inventors envision a set of machine-readable instructions and associated data, stored on a storage device in a manner more persistent than a signal in transit, the set of instructions and data comprising various modules programmed to perform the steps of the method.

Alternatively, the inventors also envision a downloadable mobile app product (“app”) with associated instructions and data for a mobile device of a user, that, when executed by a processor of the mobile device, causes the steps of the computer-implemented method to be performed in order to attain the conversion event, with the auto-generated message of the subscriber displayed to the social media poster on his or her mobile device.

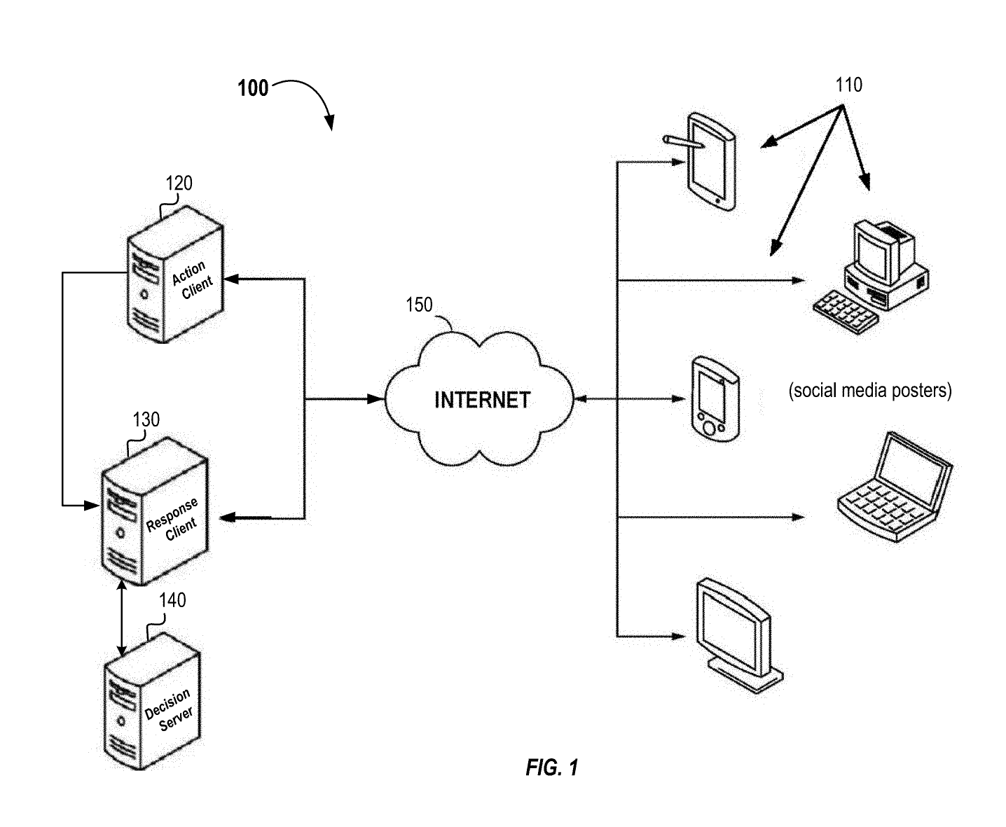

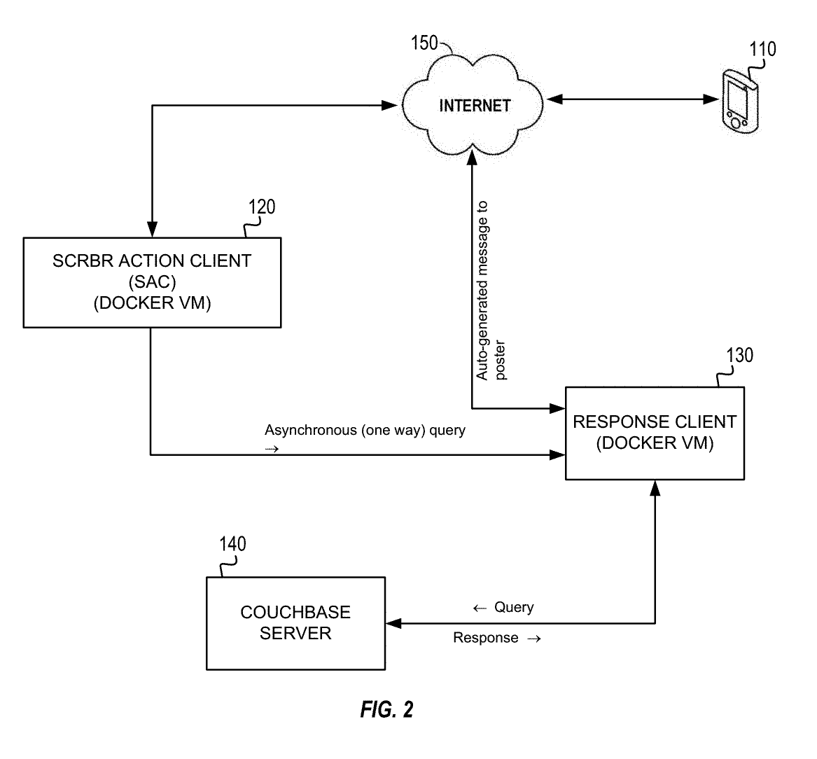

FIG. 1 illustrates an exemplary general computer system block diagram adapted to implement a method for service auto-response generation based upon a social media posting (post or tweet) to achieve a conversion event, in accordance with some embodiments; and FIG. 2 is a simplified block diagram of a specific computer system for implementing the method. In one example, this post/tweet may be related to an insurance loss event, which may include but are not limited to those events where damage is caused by any of fire, water, sewage, smoke, mold, vandalism, trauma, and structural failures, or due to force majeure conditions such as wind, fallen trees, lightening, earthquakes, hurricanes, snow loads, hail, ice dams and other acts of God. Such damage may be related to home, appliance and/or automobile damage.

Referring to FIGS. 1 and 2, computer system 100 includes one or more application servers, shown here as an SCRBR action client 120 (SAC 120), a response client 130, and a decision server 140 (also referred to hereafter as a “server node”), which are adapted to interface with one or more computing device(s) employed by a social media poster (hereafter “poster 110” for brevity) connected over a network, here shown as the internet 150. Internet 150 may be any network topology, including one or more of a personal area network (PAN), a local area network (LAN), a campus area network (CAN), a metropolitan area network (MAN), a wide area network (WAN), a broadband network (BBN), and the like.

As will be described in more detail hereafter, SAC 120, which in a specific configuration as shown in FIG. 2 is a DOCKER virtual machine, makes the connection between the exemplary method (embodied as the SCRBR algorithm and implemented by system 100), and social media sources such as TWITTER, FACEBOOK, INSTAGRAM, PINTEREST, etc. The SAC 120 is continually retrieving or “scrubbing” information from these social media sources on the internet 150. Namely, the SAC 120 scrubs posts and tweets continuously from these social media sources to search for certain keywords, and for each scrubbed post or tweet from a poster 110 that contains one or more of those keywords, sends an asynchronous query to the response client 130 with unique identifying information of the scrubbed post or tweet of poster 110. Each query is unique; this is because the query sent by the SAC 120 to the response client 130 includes the found keyword(s) along with the 16-digit post ID/tweet ID. Response client 130 can essentially be understood as a middleman between the SAC 120 and the decision server 140.

Thus, only one query is sent by the SAC 120 at a time, and then communication between the SAC 120 and the response client 130 is terminated; this is known as reactive processing. The idea behind reactive processing is to alleviate the effects of web traffic on and manage thread control in system 100.

The response client 130, which in a specific configuration as shown in FIG. 2 is a DOCKER virtual machine, receives the query of the poster 110 and then immediately sends it on to the decision server, which in the example configuration of FIG. 2 is shown embodied as a COUCHBASEO server 140 (“CBS 140”). In general, and to be explained in further detail below, the CBS 140 then performs a full text search in order to find a match, based on one or more keywords in the social media post, to a subscriber of the SCRBR service. Once this “match” is determined, CBS 140 sends a response back to the response client 130, and a canned auto-generated message is relayed directly back as an immediate reply to the poster 110 of the original post or tweet, with the goal of achieving the conversion event discussed above.

In an example, the subscriber of the SCRBR service is envisioned as a service provider and/or any service-oriented business entity. Example service provides include but are not limited to service-oriented businesses related to any of disaster restoration, auto glass repair, auto repair, home improvement, real estate sales, appliance repairs, legal and accounting services, and the like.

In determining whether there is a match between the subscriber and poster 110, CBS node 140 invokes a full text search, employing an ELASTICSEARCH search engine that lays on the CBS node 140. The ELASTICSEARCH search engine is based on LUCENE®. Developed by the Apache Software Foundation, LUCENE is a high-performance, full-featured text search engine library written entirely in JAVA. It is a technology suitable for nearly any application that requires full-text search, especially cross-platform.

LUCENE thus provides a distributed, multitenant-capable, full-text search engine with an HTTP web interface and schema-free JavaScript object (JSON) documents. ELASTICSEARCH was developed in JAVA and released as open source under the terms of the Apache license. When configured as downloadable software, ELASTICSEARCH may be adapted for use in searching, indexing, organizing, managing, processing, storing, retrieving, analyzing, and reporting information and data. ELASTICSEARCH may also be adapted for use in cloud computing and software as a service (SAAS) services, namely, hosting computer software applications of others for the afore-mentioned searching, indexing, organizing, managing, processing, storing, retrieving, analyzing, and reporting of information and data.

As neither APACHE's CAMEL servlets nor JAVA's servlets are capable of handling the web traffic efficiently, the response client 130 uses the SCALA programming language built on a PLAY® Framework to communicate with the CBS node 140. Like JAVA, SCALA is object-oriented, and uses a curly-brace syntax reminiscent of the C programming language.

Unlike JAVA, SCALA has many features of functional programming languages like SCHEME, STANDARD ML and HASKELL, including currying, type inference, immutability, lazy evaluation, and pattern matching. PLAY provides predictable and minimal resource consumption (CPU, memory, threads) for highly-scalable applications.

Of note, when the response client 130 receives the match determination response back from the CBS node 140, it outputs a unique, canned, auto-generated response message (of the subscriber) back to the poster 110. In one example, the response client 130 employs Twitter4J, which is built on top of the TWITTER API, to interface with TWITTER. Twitter4J is an unofficial Java library for the TWITTER API, and is used to integrate a Java application with the Twitter service.

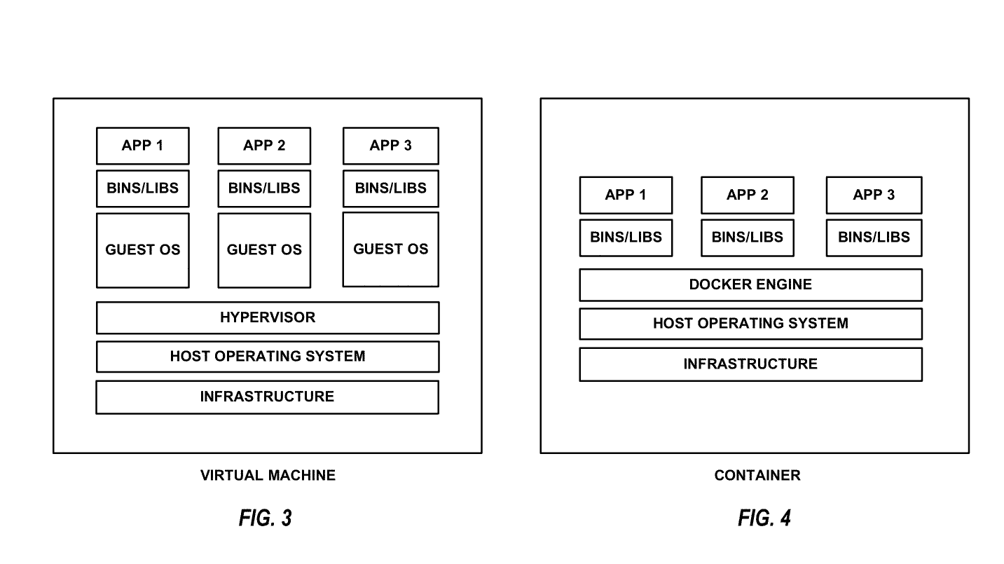

FIG. 3 is a block diagram describing the architecture of a virtual machine, and FIG. 4 is a block diagram describing the general architecture of a container. As noted above, a core goal of the SCRBR Service is in achiever a conversion event where the poster's response (tweet/post) leads to a business interaction between a subscriber of the SCRBR service and the poster, directing the poster to a landing page of the subscriber via an auto-generated message, for example. As noted, the SAC 120 continually receives streaming data from social media sources (posts and tweets). The SAC 120 makes the connection between the exemplary method embodied as the SCRBR algorithm and implemented by system 100, and social media sources such as TWITTER, FACEBOOK, INSTAGRAM, PINTEREST, etc. The SAC 120 is continually retrieving information from these social media sources on the internet 150.

In an example configuration, the SAC 120 and the response client 130 are each a type of virtual machine. A virtual machine (VM) is an operating system (OS) or application environment that is installed on software, which imitates dedicated hardware. The end user has the same experience on a virtual machine as they would have on dedicated hardware. As shown in FIG. 3, specialized software, called a hypervisor, emulates the PC client or server's CPU, memory, hard disk, network and other hardware resources completely, enabling virtual machines to share the resources. The hypervisor can emulate multiple virtual hardware platforms that are isolated from each other, allowing VMs to run Linux and WINDOWS Server operating systems on the same underlying physical host. Virtualization limits costs by reducing the need for physical hardware systems. VMs more efficiently use hardware, which lowers the quantities of hardware and associated maintenance costs, and reduces power and cooling demand. They also ease management because virtual hardware does not fail. Administrators can take advantage of virtual environments to simplify backups, disaster recovery, new deployments and basic system administration tasks.

VMs do not require specialized, hypervisor-specific hardware. Virtualization does, however, require more bandwidth, storage and processing capacity than a traditional server or desktop if the physical hardware is going to host multiple running VMs. VMs can easily move, be copied and reassigned between host servers to optimize hardware resource utilization. Because VMs on a physical host can consume unequal resource quantities—one may hog the available physical storage, while another stores little—IT professionals must balance VMs with available resources.

The use of VMs also comes with several important management considerations, many of which can be addressed through general systems administration best practices and tools that are designed to manage VMs. There are some risks to consolidation, including overtaxing resources or potentially experiencing outages on multiple VMs due to one physical hardware outage. While these cost savings increase as more VMs share the same hardware platform, it does add risk. It is possible to place hundreds of VMs on the same hardware, but if the hardware platform fails, it could take out dozens or hundreds of VMs.

Vendors who offer virtual machine software include but are not limited to DOCKER, CLOUDREADY® by NEVERWARE® Inc., VMWARE®, AMAZON WEB SERVICES®, and MICROSOFT. Several open source alternatives are evolving rapidly, with new features and increased stability.

Cloud computing layers additional technologies, such as self-service provisioning and chargeback, onto virtualization. For example, in a virtualized data center, the IT staff will spin up new VMs based on user demand or a new project. In a cloud environment, a user can provision VMs from a self-service catalog and specify resources without interacting with the underlying physical equipment.

In an example implementation, system 100 employs one or more DOCKER® virtual machines. The DOCKER platform is essentially a containerization platform, in which hardware (a server) runs containers but not within the OS of the server, as each container has its own OS. Containers and VMs have similar resource isolation and allocation benefits—but a different architectural approach allows containers to be more portable and efficient than the virtual machine.

The structural differences between a virtual machine and container architecture. The VM structure of FIG. 3 includes the application, necessary binaries and libraries, and guest OS. VMs are an abstraction of physical hardware turning one server into many servers. The hypervisor allows multiple VMs to run on a single machine. Each VM includes a full copy of an operating system, one or more apps, necessary binaries and libraries—taking up tens of GBs. VMs can also be slow to boot.

The container structure of FIG. 4 includes the application and all of its dependencies, but shares the kernel with other containers, running as isolated processes in user space on the host OS. DOCKER containers are not tied to any specific infrastructure; they run on any computer, on any infrastructure, and in any cloud. Containers are therefore an abstraction at the app layer that packages code and dependencies together. Multiple containers can run on the same machine and share the OS kernel with other containers, each running as isolated processes in user space. Containers take up less space than VMs (container images are typically tens of MBs in size), and start almost instantly.

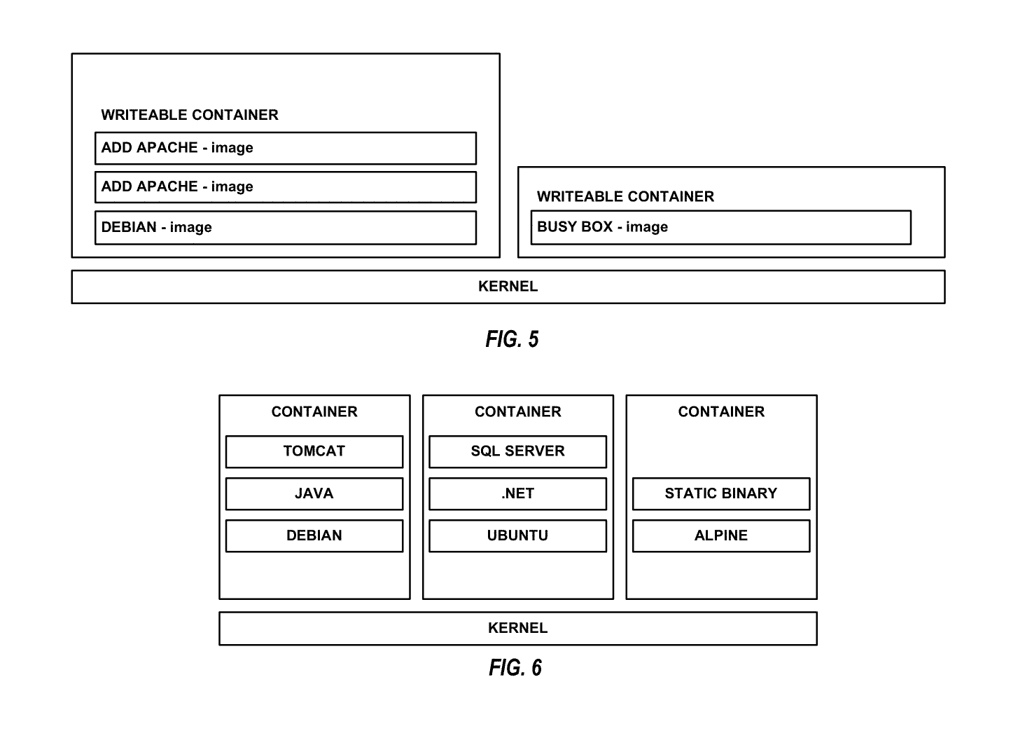

FIGS. 5 and 6 are example simple block diagrams of a container infrastructure, such as the containerization platform offered by DOCKER. These containers wrap a piece of software in a complete filesystem that contains everything needed to run: code, runtime, system tools, and system libraries; anything that can be installed on a server. This guarantees that the software will always run the same, regardless of its environment.

A container image is a lightweight, stand-alone, executable package of a piece of software that includes everything needed to run it: code, runtime, system tools, system libraries, settings. Containerized software will always run the same, regardless of the environment. Containers isolate software from its surroundings, for example, the differences between development and staging environments, and help reduce conflicts between teams running different software on the same infrastructure.

As noted above, containers running on a single machine share the same operating system kernel, hence start instantly and use less RAM. Images are constructed from layered filesystems and share common files, making disk usage and image downloads much more efficient, hence its lightweight imprint. DOCKER containers are based on open standards, enabling containers to run on all major Linux distributions and on MICROSOFT WINDOWS®-based apps, as well as on top of any infrastructure. Containers are secure by default in that they also isolate applications from one another and the underlying infrastructure, while providing an added layer of protection for the application.

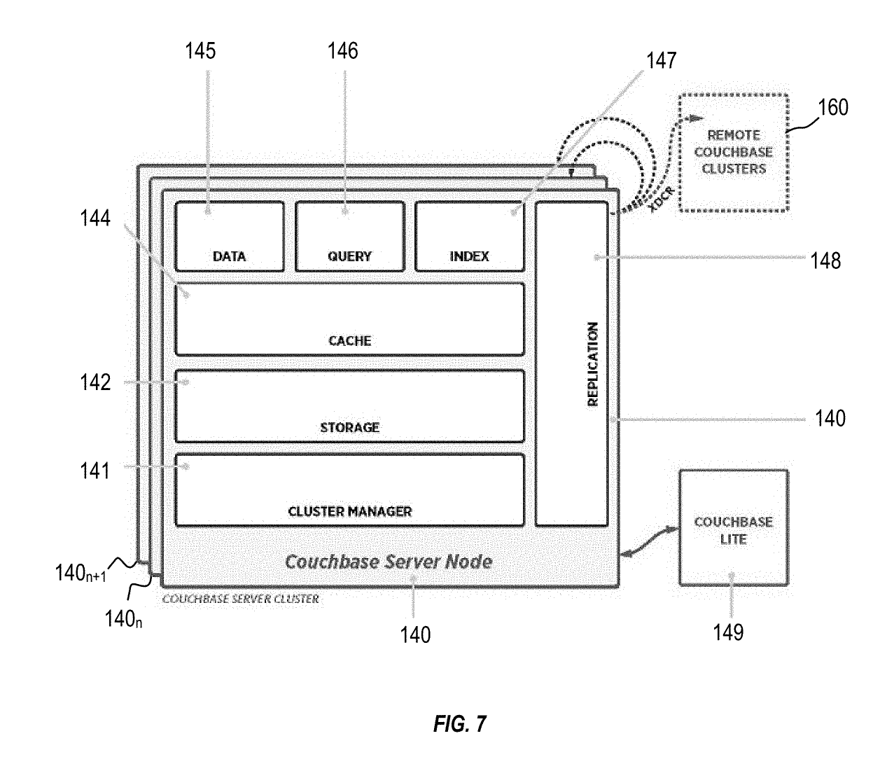

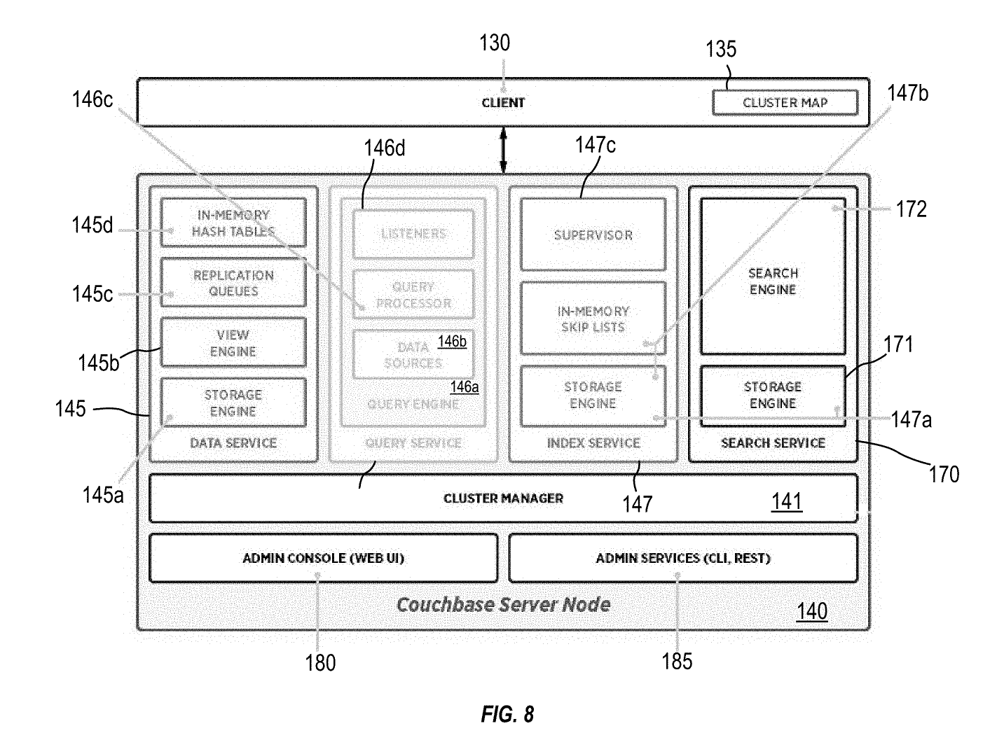

FIG. 7 is a block diagram describing the general architecture of an exemplary server node for determining a match between a post by a social media poster and a subscriber, according to the exemplary computer-implemented method; and FIG. 8 is a block diagram describing the server node shown in FIG. 7 in more detail. Referring to FIGS. 7 and 8, the COUCHBASE server node (CBS node 140) is a NoSQL document database with a distributed architecture for performance, scalability, and availability. It enables developers to build applications easier and faster by leveraging the power of SQL with the flexibility of JSON. The CBS node 140 performs multi-dimensional scaling, and includes scale out and scale up options with flexible topologies, has a homogeneous topology for all services on all nodes, and a service-based topology for selected services on specific nodes. The CBS node 140 employs CRAM/SCRAM authentication, requires authorization with RBAC for administrations, can encrypt on disk and over the wire, and includes fine-grained auditing features.

The cluster manager 141 has full topology orchestration, automatic failure detection, and push-button scale out feature sets. Storage 142 comprises optimized storage engines, an asynchronous I/O, and automatic compaction. Cache 144 has a built-in, memory-first architecture.

The CBS node 140 includes a data service 145, a query service 146, and an index service 147. The data service 145 offers sub millisecond key-value access, has built-in high speed replication and persistence, and includes local indexes for analytics and spatial queries. The query service 146 employs N1QL (SQL) query processing, with full SQL+JSON extensions, a query parser, planner, and an optimizer with optimizer hints. The index service 147 has a plurality of high performance, Global Secondary Indexes and partial indexes, has memory-optimized structures and lock-free, high concurrency, index maintenance.

The CBS node 140 further includes a Cross Data Center Replication (XDCR) module 148 and a COUCHBASE LITE module 149 in operative communication therewith. The XDCR module 148 has fast memory-to-memory replication, is filterable and multi-directional, and can support flexible topologies such as tree, hub & spoke, and the like. The COUCHBASE LITE module 149 is a device-resident with local storage, a small footprint, bi-directional data sync, and has access to offline data.

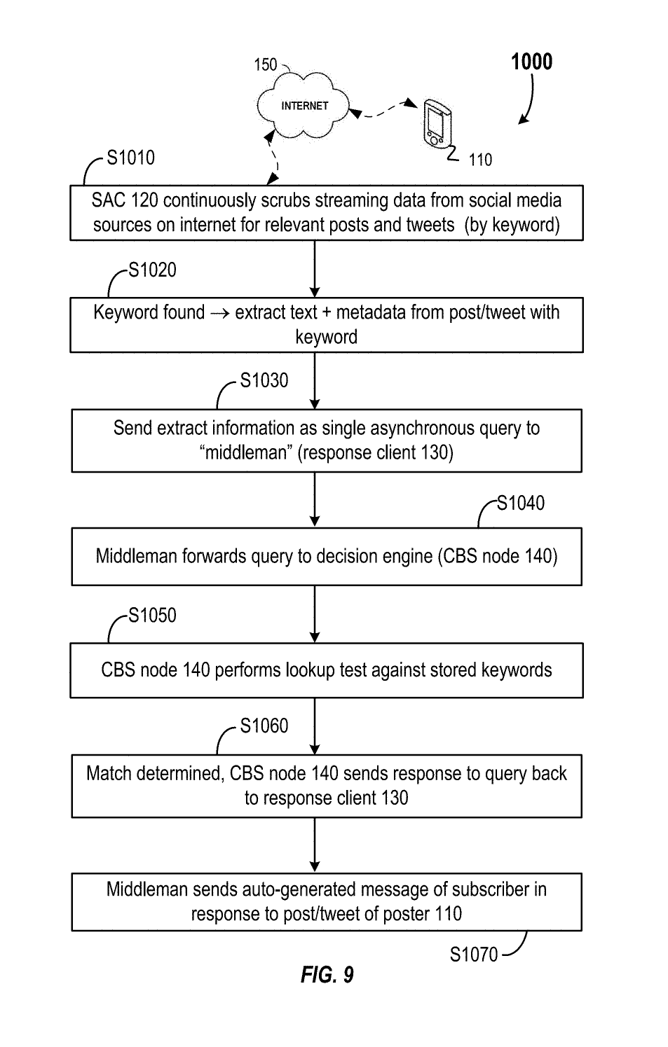

FIG. 9 is a flow diagram to describe a method for service auto-response generation based upon a social media posting, according to the example embodiments. As noted above, the commercial platform in one example is a self-serve website in which a subscriber may set their profile, preferences, and budget for their campaign, including time windows to try and match up with posters 110. All toward the goal of a conversion event, the subscriber may subscribe by the day, month, year, etc., or set hourly limits for their campaign to send the auto-generated response message upon a match.

As shown in FIG. 9, the actual input to the SCRBR algorithm (“process 1000”) is a JavaScript object (JSON), which had metadata. Each tweet or post has a JSON with metadata in it. The SAC 120 is configured to continuously scrub (S1010) the streaming data of social media sources on the internet to search for one or more keyword(s) in a given post or tweet. As part of the scrubbing function, and upon detection of one or more of these given keywords, the SAC 120 then extracts (S1020) the text (of the post or tweet, inclusive of keyword(s)) and the metadata from the JSON in the poster's 110 post or tweet. The following information is then pulled by the SAC 120 from the metadata to assemble the asynchronous query to be sent on to the response client 130: (a) audience information, which is designed to help the subscribers learn more about their target audiences, and includes aggregate information about one or more of geography, demographics, purchase behavior, and the like; (b) the location information (obtained from geo-fencing); (c) the actual text in the tweet or post, and (d) the hashtag ID (user ID) of the post or tweet.

Geo-fencing is a feature in a software program that uses the global positioning system (GPS) or radio frequency identification (RFID) to define geographical boundaries. Geo-fencing allow an administrator to set up triggers so when a computing device enters (or exits) the boundaries defined by the administrator, an alert is issued. Many geo-fencing applications incorporate GOOGLE EARTH®, allowing administrators to define boundaries on top of a satellite view of a specific geographical area. Other applications define boundaries by longitude and latitude or through user-created and Web-based maps.

Geofence virtual barriers can be active or passive. Active geofences require an end user to opt-in to location services and a mobile app to be open. Passive geofences are always on; they rely on Wi-Fi and cellular data instead of GPS or RFID and work in the background.

A hashtag is simply a keyword phrase, spelled out without spaces, with a pound sign (#) in front of it. For example, #InboundHour and #ChocolateLovers are both hashtags. Typically, the best hashtags are those composed of a single word or a few letters, with the keyword often kept under 6 characters.

The poster 110 can put these hashtags anywhere in their social media posts/tweets—at the beginning, end, or anywhere in between. Hashtags tie public conversations from all different users into a single stream, which you can find by searching for a hashtag, clicking on one, or using a third-party monitoring tool like HUBSPOT®'s Social Inbox. In order for a post (or tweet) with a hashtag to appear in anyone's search, the post must be public.

In process 1000, the stated goal is to match up based on keyword detection in their scrubbed post or tweet, the poster 110 with a subscriber of the SCRBR service for auto-response message generation; attaining the conversion event. Per the SCRBR algorithm, the extracting step S1020 thus involves pulling a certain amount of text per tweet/post; a tweet contains up to 167 characters. The extracted information is then sent as a query by the SAC 120 to the response client 130 (step S1030). As middleman, the response client 130 sends the single asynchronous query generated by the SAC 120 onto the CBS node 140 (step S1040).

The CBS node 140 then performs a lookup test (S1050) based on the received query using ELASTICSEARCH, against stored keywords in storage 142. There are fifty (50) max lookups per tweet; in other words 0 to 50 true letter words that can be looked up, ignoring spacing. The idea here is to find a match or link between a subscriber and the [poster 110 based on the keyword(s). The following is a representative example of the processing within the CBS node 140: (1) is there a match on a single keyword/location (i.e., give us every subscriber in Baltimore that matches the poster 110's keyword; if there is a match (“YES” for the selected tweet/post, hashtag, audience information), the CBS node 140 sends a response (step S1060) to the response client 130, which in turn immediately outputs the auto-generated message (step S1070) of the matched-up subscriber to the poster 110. In the event of ties between matches (e.g., if greater than one (>1) tweet/post has a match, ELASTISEARCH will look for a secondary words to break the tie. As the ELASTISEARCH engine lays on top of the CBS node 140, it is not network-based and essentially does all the “legwork” for the CBS node 140.

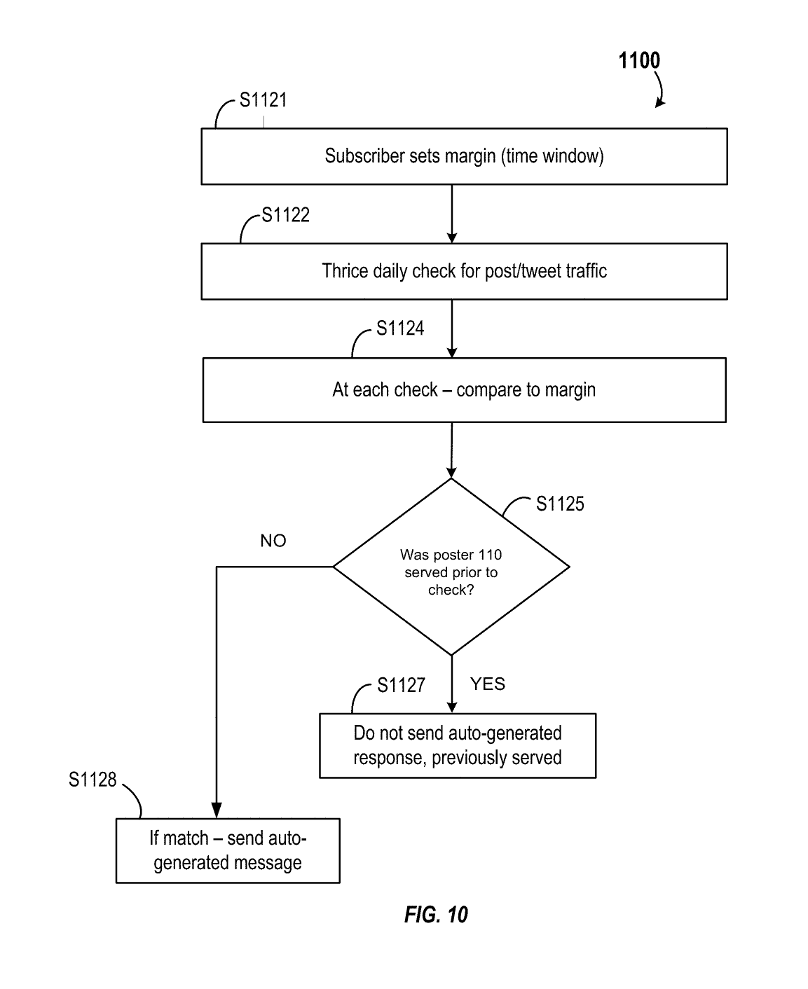

FIG. 10 is a flow diagram to describe an auto-scaling methodology that is implemented in parallel with the method for service auto-response generation described in FIG. 9. Concurrently with the above, the CBS node 140 iterates a frequency capping algorithm (FCA) to verify that the particular poster 110 (just served) has not been served recently or previously. Frequency capping is a term in advertising that means restricting (capping) the number of times (frequency) a specific visitor to a website is shown a particular advertisement. This restriction is applied to all websites that serve ads from the same advertising network. Frequency capping is a feature within ad serving that allows to limit the maximum number of impressions/views a visitor can see a specific ad within a period of time. For example, three (3) views/visitor/24-hours means after viewing this ad three (3) times, any visitor will not see it again for 24 hours. This feature uses cookies to remember the impression count. Non-cookies privacy-preserving implementation is also available.

Frequency capping is often cited as a way to avoid banner burnout, the point where visitors are being overexposed and response drops. This may be true for direct-response campaigns whose effectiveness is measured in click-throughs, but it might run counter to campaigns whose goal is brand awareness, as measured by non-click activity. In social media, like YouTube video campaigns, failing to set up frequency capping may result in negative comments as the video ad becomes annoying, no matter how good it may be. Such comments may hurt the brand image, rather than boost its awareness.

Referring to FIG. 10, and in general, and based on a margin set by the subscriber (step S1121) the FCA (process 1100) checks poster/tweeter traffic 3× daily (step S1122) and compares it to the margin (step S1124), or time window specified by the subscriber. In an example, the subscriber may specify that they want their campaign to generate the auto-generated responses to a determined matched-up poster 110 between 8 AM to 8 PM in their local time zone. The idea of setting the margin is thus to avoid sending auto-generated responses from the same subscriber to the same poster/tweeter that has just recently received the auto-generated message from that subscriber. If within the margin or time window the FCA 1100 has determined at step S1125 that the poster was previously served an auto-generated message, no further message is sent, see SI 127; otherwise upon the match if poster 110 has not yet received a reply from the subscriber, the auto-generated message is sent (step S1128).

In accordance with the example embodiments, the system 100 utilizes CLOUDWATCH® by AMAZON WEB SERVICES® (AWS) to control the quick spin-up or spin-down of additional PODs of processing (such as DOCKER VMs 120, 130 and CBS nodes 140) depending on system loading due to web traffic. But before this is done, a benchmarking process is performed to set benchmarking alerts.

The idea behind benchmarking is to literally throw “tons of mocked data” at the SCRBR system 100 (e.g., billions of requests) to see how the system 100 reacts. Benchmarking alerts are then set for auto-scaling of the various nodes, inclusive of DOCK VMs 120, 130 and the CBS node 140.

Auto-scaling is employed so that the SCRBR system does not become bogged down in heavy web traffic periods, thereby alleviating potential bottlenecks. For example, assume that process 1000 tells the response client 130 to maintain one (1) POD of processing. If auto-scaling metrics determine that the SCRBR system 100 has reached some predetermined capacity limit (i.e., a benchmark alert determined from the benchmarking process, such as 80% of CPU processing), a second POD will be spun-up alongside the first POD. Accordingly, as load/traffic increases/decreases, the auto-scaling rules spin-up/spin-down PODs of processing so as not to use up resources.

CLOUDWATCH enables the retrieval of statistics as an ordered set of time-series data, known as metrics. These metrics may be used to verify that the SCRBR system 100 is performing as expected. For example, AMAZON EC2® sends metrics to CLOUDWATCH that describe auto-scaling instances for the SCRBR algorithm (process 100). These metrics are available for any EC2 instance, not just those in an auto-scaling group. If enabled in process 1000, auto-scaling groups can send metrics to CLOUDWATCH that describe the group itself.

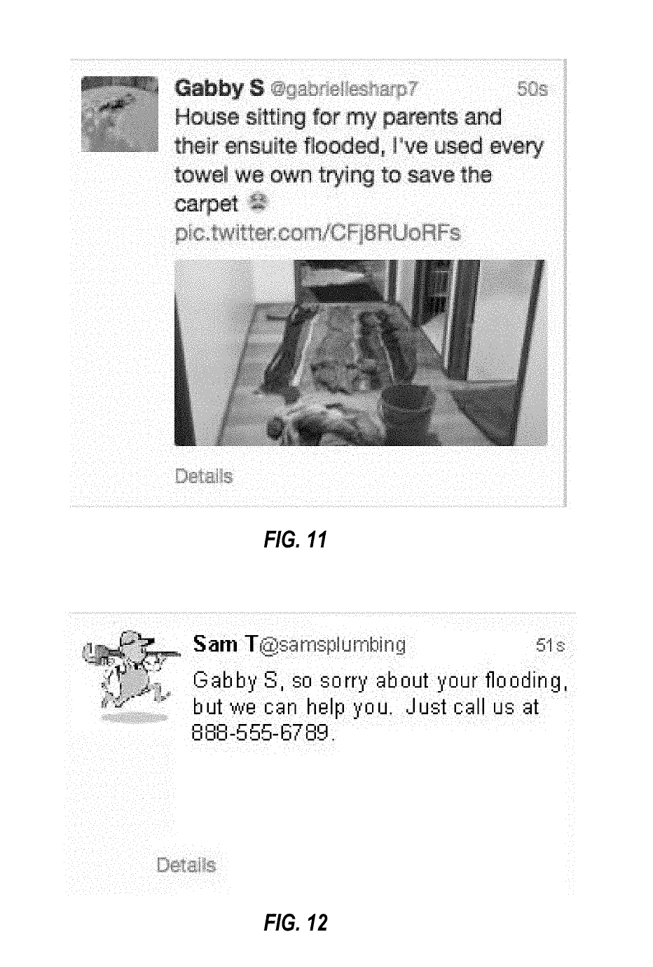

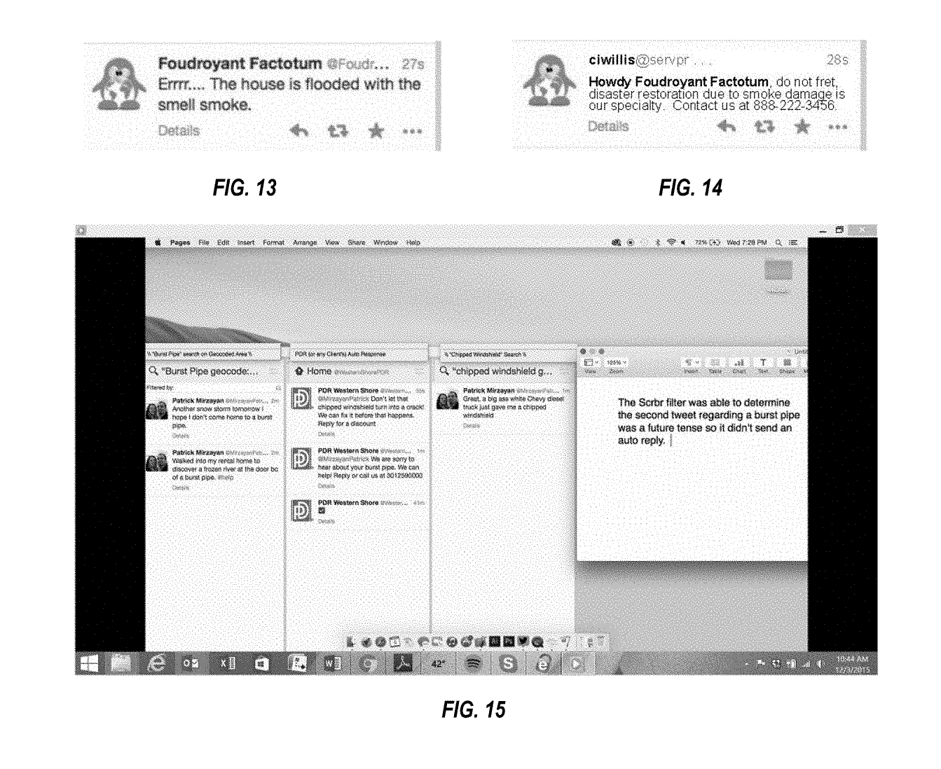

FIGS. 11 through 15 show screenshots of a chat box illustrating an example post on TWITTER evaluated by the exemplary method as embodied by the SCRBR algorithm, and that of an example chat box illustrating an example auto-generated response by the subscriber client selected by the SCRBR algorithm to address the scrubbed post. As can be seen by these two sets of figures, in response to a scrubbed social media posting, and upon the determined match between poster and subscriber client, the subscriber client generates an auto-response to initiate contact.

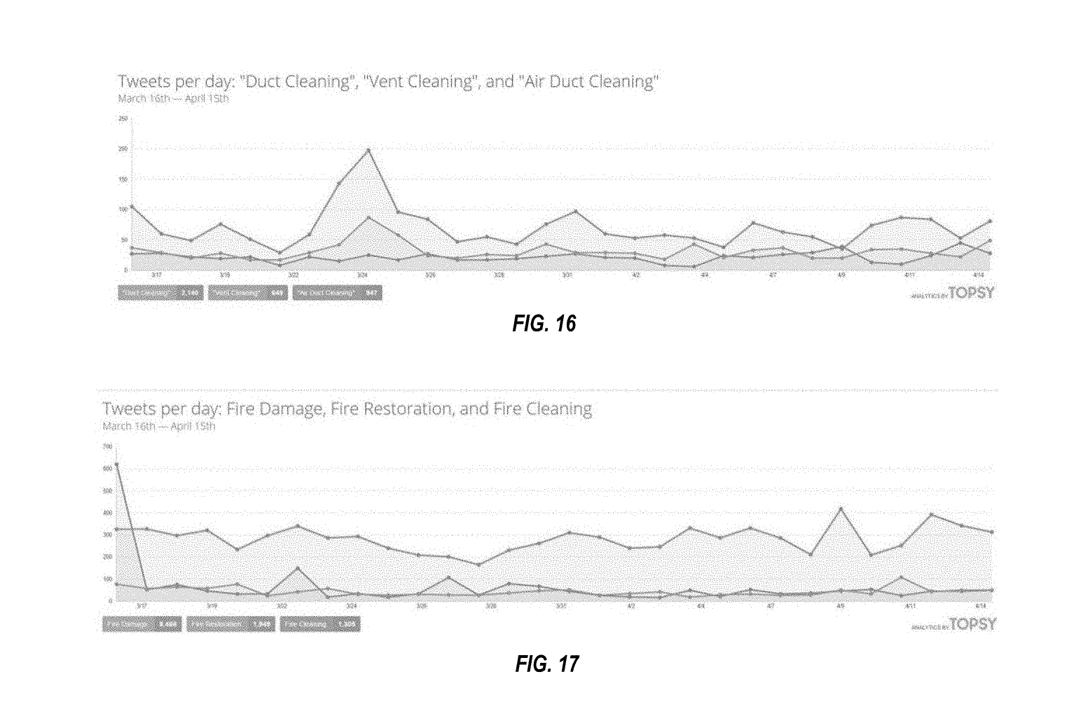

FIG. 16 is a screenshot of another timeline example using the exemplary method as embodied by the SCRBR application to address separate burst pipe and broken windshield tweets. Here, the third from left chat box shows an example post on TWITTER (cracked windshield keyword), with a 55 sec delay before the auto-generated response by the assigned subscriber client is sent to the poster. Additionally, a second tweet, see the left-most chat box, shows an example tweet with a pipe burst keyword that is immediately evaluated by the SCRBR algorithm, with a subsequent chat box showing the auto-generated response by the subscriber client selected or assigned by the SCRBR algorithm to address the scrubbed water damage post. Note that no auto-generated response is sent in reply to the subsequent tweet on the water damage event, as the tweet was future tense. This further illustrates the sensitivity of the SCRBR algorithm.

FIGS. 17 through 21 are screenshots showing various graphs of a one month snapshot of tweets in spring 2015 which tracks the number of selected keywords discovered daily therein, as tracked by the Twitter analytics vendor TOPSY® LABS, Inc., which until bought by APPLE and subsequently shut down in December 2015, was an independent social search and analytics company based in San Francisco, Calif. A certified TWITTER partner, TOPSY has maintained a comprehensive index of tweets, numbering in hundreds of billions, dating back to TWITTER's inception in 2006, and offered products to search, analyze and draw insights from conversations and trends on various public social websites.

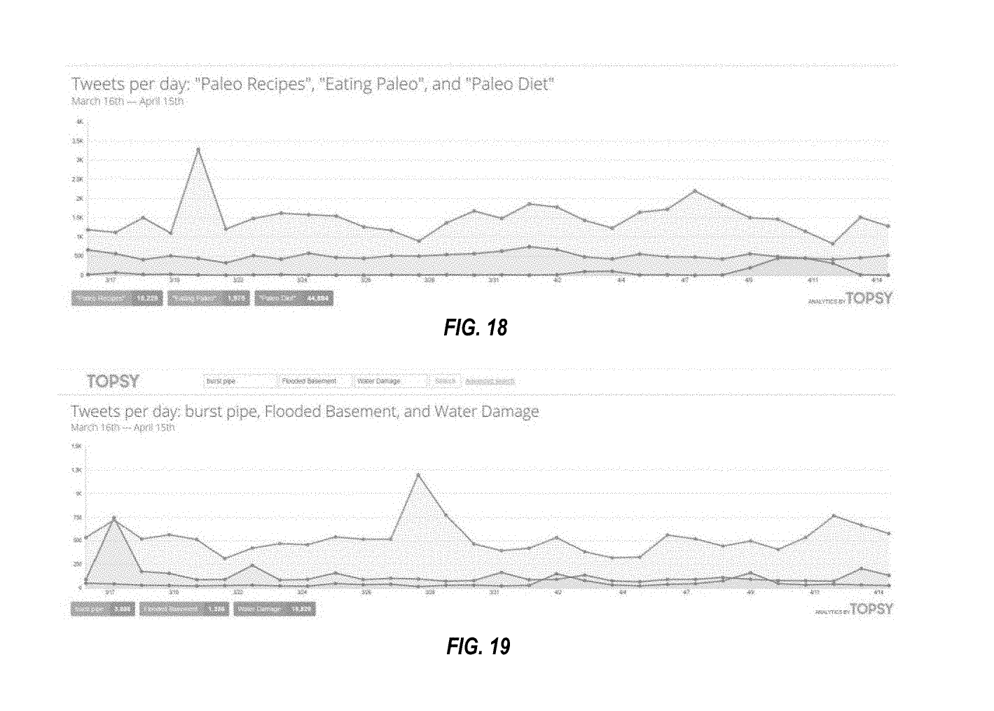

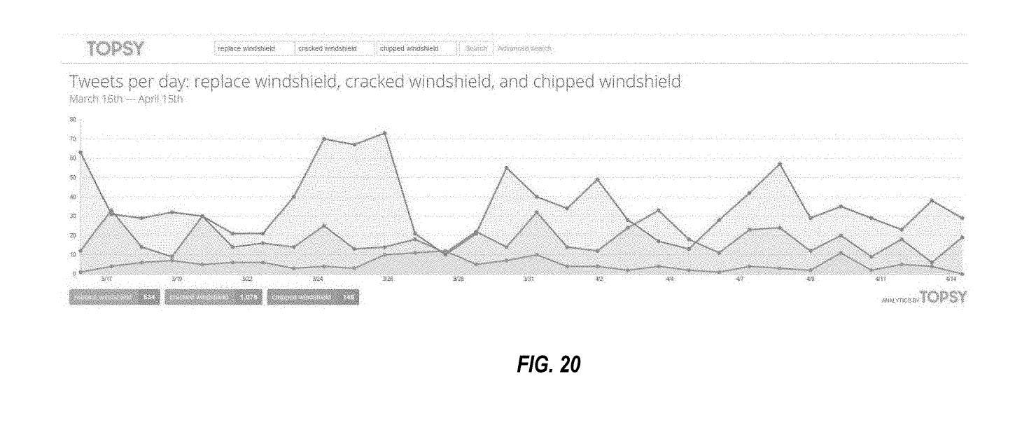

As shown, each graph is directed to the tracking of different keywords in tweets, such as those related to duct cleaning (FIG. 17), fire damage-related keywords (FIG. 18), Paleo-related keywords (FIG. 19, to illustrate a differentiator), water damage-related keywords (FIG. 20), and windshield damage-related keywords (FIG. 21). Accordingly, in these snapshots, TOPSY determined that in this one-month snapshot, for just a single social media source (TWITTER) and for merely a handful of insurance loss-type events, there were well over 38,000 relevant tweets that had some kind of keyword therein that might be highly relevant to a subscriber of the SCRBR service.

The present invention, in its various embodiments, configurations, and aspects, includes components, methods, processes, systems and/or apparatuses substantially as depicted and described herein, including various embodiments, sub-combinations, and subsets thereof. Those of skill in the art will understand how to make and use the present invention after understanding the present disclosure. The present invention, in its various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the example embodiments has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure.

The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

The embodiments described herein may be implemented in digital electronic circuitry, or in computer hardware, firmware, software, or in combinations of them. The embodiments can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computer system. A computer program can be deployed to be executed on one computer or on multiple computers at one site or distributed across multiple sites and interconnected by a communication network.

Although the example embodiments may have occasionally described components and functions implemented in the embodiments with reference to one or more particular standards and/or protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

As the invention may be embodied as a method, of which an example has been provided, any acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

We claim:

1. A computer-implemented method implemented by processing power of a computing device, the method adapted to link a social media poster to a subscriber so as to attain a conversion event, comprising:
continually scrubbing one or more social media sources on the internet to search for a social media posting posted by a poster,
searching for at least one selected or predetermined keyword contained in the content of the social media posting,
extracting information from the social media posting upon detection of the at least one keyword therein,
analyzing the extracted information in an effort to link the poster and subscriber, and
determining if a match is found between the subscriber and poster based on the analysis, wherein upon a found match an auto-response message of the subscriber is sent to the poster to initiate contact therewith an attain the conversion event, the generated auto-response addressing content within the social media posting,
wherein the scrubbing, searching, extracting, analyzing, and determining steps are performed by computer software adapted to run on computer hardware.

2. The method of claim 1, wherein the subscriber is a service-oriented business related to any of disaster restoration, auto glass repair, auto repair, home improvement, real estate sales, and appliance repairs.

3. The method of claim 1, wherein content in the social media posting is related to an insurance loss event.

4. The method of claim 3, wherein the insurance loss event is selected from a group of events where damage is caused, the group of events comprising fire, water, sewage, smoke, mold, vandalism, trauma, and structural failures, wind, fallen trees, lightening, earthquakes, hurricanes, snow loads, hail, ice dams, and other acts of God.

5. The method of claim 1, wherein the conversion event is embodied as a business interaction between the subscriber and the poster, directing the poster to a landing page of the subscriber via the auto-generated message.

6. The method of claim 1, wherein
the social media posting has a JSON with metadata in it, and
extracting further includes pulling information from the metadata to assemble an asynchronous query for analysis in the analyzing step

7. The method of claim 6, wherein the query to be sent for analysis includes:
(a) audience information related to the posting,
(b) location information about the posting from geo-fencing,
(c) text within the posting, and
(d) a hashtag ID of the posting.

8. The method of claim 1, wherein analyzing the extracted information includes comparing the information against a lookup table of stored keywords associated with subscribers to find a match.

9. The method of claim 1, wherein if the determining step determines that there is greater than one match between the poster and subscribers, a secondary keyword is evaluated to break the tie.

10. The method of claim 1, wherein in parallel frequency capping algorithm is executed to auto-scale processing nodes based on heavier or lighter web traffic periods so as to conserve resources.

11. The method of claim 10, wherein benchmarking alerts are determined and serve as a capacity limit for auto-scaling of the nodes.

12. A non-transitory, computer-readable information storage media having stored thereon information, that when executed by a processor causes the steps of claim 1 to be performed.

13. A computer system adapted to link a social media poster to a subscriber so as to attain a conversion event, comprising:
a processing hardware set, and
a computer readable storage device medium, wherein
the processing hardware set is structured, connected and/or programmed to run program instructions stored on the computer readable storage medium and associated data, the system further including:
an action client programmed to continually scrub one or more social media sources on the internet to search for a social media posting posted by a poster, to search for at least one selected or predetermined keyword contained in the content of the social media posting, and to extract information from the social media posting upon detection of the at least one keyword therein,
a decision client programmed to analyze the extracted information in an effort to link the poster and subscriber, and determine if a match is found based on the analysis, and
a response client programmed to, upon a found match by the decision client, send an auto-response message of the subscriber to the poster so as to initiate contact therewith and attain the conversion event, the generated auto-response addressing content within the social media posting.

14. The system of claim 13, wherein the subscriber is a service-oriented business related to any of disaster restoration, auto glass repair, auto repair, home improvement, real estate sales, legal and accounting services, and appliance repairs.

15. The system of claim 13, wherein content in the social media posting is related to an insurance loss event.

16. The system of claim 15, wherein the insurance loss event is selected from a group of events where damage is caused, the group of events comprising fire, water, sewage, smoke, mold, vandalism, trauma, and structural failures, wind, fallen trees, lightening, earthquakes, hurricanes, snow loads, hail, ice dams, and other acts of God.

17. The system of claim 13, wherein the conversion event is embodied as a business interaction between the subscriber and the poster, directing the poster to a landing page of the subscriber via the auto-generated message.

18. The system of claim 13, wherein
the social media posting has a JSON with metadata in it, and
the extracting by the action client includes pulling information from the metadata to assemble an asynchronous query for analysis by the decision server.

19. The system of claim 18, wherein the query to be analyzed by the decision server includes:
(a) audience information related to the posting,
(b) location information about the posting from geo-fencing,
(c) text within the posting, and
(d) a hashtag ID of the posting.

20. The system of claim 13, wherein in analyzing the extracted information the decision server compares the information against a lookup table of stored keywords associated with subscribers to find a match.

21. The system of claim 13, wherein if the decision server determines that there is greater than one match between the poster and subscribers, a secondary keyword is evaluated to break the tie.

22. The system of claim 13, wherein the decision server executes a frequency capping algorithm in parallel for auto-scaling to spin-up additional server nodes or spin-down server nodes based on heavier or lighter web traffic periods.

23. The system of claim 22, wherein benchmarking alerts are determined and serve as a capacity limit for auto-scaling of the server nodes.

24. A method implemented by a computing device to link a social media poster of a post or tweet containing content related to an insurance loss event to a subscriber service provider, comprising:
continually scrubbing one or more social media sources on the internet to search for a social media posting posted by a poster,
extracting information from the social media posting upon detection of at least one keyword therein, and
comparing the extracted information to a stored set of keywords, whereupon if a match is found between the subscriber and poster an auto-response message of the subscriber is sent to the poster to attain the conversion event,
wherein the scrubbing, extracting, and comparing steps are performed by computer software adapted to run on computer hardware.

25. The method of claim 24, wherein the insurance loss event is selected from a group of events where damage is caused, the group of events comprising fire, water, sewage, smoke, mold, vandalism, trauma, and structural failures, wind, fallen trees, lightening, earthquakes, hurricanes, snow loads, hail, ice dams, and other acts of God.

26. The method of claim 24, wherein the auto-response message is designed to compel a business interaction between the subscriber and the poster.

27. The method of claim 24, wherein
the social media posting has a JSON with metadata in it, and
extracting further includes pulling information from the metadata to assemble an asynchronous query for analysis in the analyzing step

28. The method of claim 27, wherein the query to be sent for analysis includes:
(a) audience information related to the posting,
(b) location information about the posting from geo-fencing,
(c) text within the posting, and
(d) a hashtag ID of the posting.

29. The method of claim 24, wherein in parallel a frequency capping algorithm is executed to auto-scale processing nodes based on heavier or lighter web traffic periods, and pre-determined benchmarking alerts serve as a capacity limit for auto-scaling of the nodes.

30. A computer system adapted to link a social media poster of a post or tweet containing content related to an insurance loss event to a subscriber service provider, comprising:
an action client adapted to continually scrub one or more social media sources on the internet to search for a social media posting posted by a poster, and to extract information from the social media posting upon detection of at least one keyword therein,
a decision server adapted to compare the extracted information to a stored set of keywords, and
a response client, whereupon if a match is found between the subscriber and poster, the response client sends an auto-response message of the subscriber to the poster to initiate contact.

31. The system of claim 30, wherein
the action client and response client are virtual machines, and
the decision server is one or more COUCHBASE server nodes.
